(19) United States
(12) Patent Application Publication
(10) Pub. No.: US 2004/0089650 A1
(43) Pub. Date: May 13, 2004

(54) High efficiency inline fluid heater

(76) Inventors: Dexter E. Diepholz, Hendersonville, NC (US); Neil B. Farnam, Asheville, NC (US); Mark A. Mathes, Hendersonville, NC (US)

Correspondence Address: Joseph T. Guy, Ph.D, Nexsen Pruet Jacobs & Pollard, LLC, PO Drawer 10648, Greenville, SC, 29603-0648, US

(21) Appl. No.: 10/392,169

(22) Filed: Mar. 19, 2003

Related U.S. Application Data
(63) Continuation-in-part of application No. 10/291,049, filed on Nov. 8, 2002.

(51) Int. Cl. H05B 3/02

(52) U.S. Cl. 219/488

(57) ABSTRACT

A heater for heating flowing fluid. The heater comprises a cylindrical heating chamber comprising an inlet at one base and on outlet at a second base. The flowing fluid traverses parallel to the chamber. A resistive heating element is received in the chamber wherein the resistive heating element comprises a rectangular base. The rectangular base comprises a long axis and short axis and the long axis is parallel to the chamber. The base comprises a multiplicity of first slots on one side and a multiplicity of second slots on a second side. A double helix filament is received in the first slots and the second slots.

### RELATED APPLICATION

The present invention is related to co-pending U.S. patent appl. Ser. No. 10/291,049, filed Nov. 8, 2002 and is a continuation-in-part application thereof.

### TECHNICAL FIELD

The present invention is related to an inline fluid heater. More specifically, the present invention is related to a highly efficient inline fluid heater particularly adapted for heating flowing air.

### BACKGROUND

Devices for heating fluid, particularly flowing air, are commonly employed in many areas of commerce. Hair dryers, heat guns and similar devices, for example, utilize a resistance based heating element to heat air flowing past the heating element.

Electrical resistance heaters typically comprise a support with a resistance filament, particularly a wire filament, secured thereto. Each end of the wire filament is attached to a power supply. U.S. Pat. No. 5,298,723 provides a representative resistive heating element comprising a helical coil filament wrapped around a ceramic or insulating comb. Air flows past the helical coils allowing heat to transfer via convection from the heated coils to the air. One deficiency with the heating element of U.S. Pat. No. 5,298,723 is the poor efficiency of heat transfer from the coils to the flowing air.

A common problem associated with resistance type heaters is the proximity of the terminals. It is highly desirable to have the terminals at the cool side of the heating element. This configuration acts to cool the terminal, and contacts, and insures that they do not become overheated. If the terminal is towards the exit side of the heating element the terminal is heated by conduction heating, from the resistive element, and from convection from the heated air. Therefore, coiled resistive heating elements have generally been considered inappropriate for use in enclosed tube heaters where air passes into one end of a tube, in the proximity of a terminal, and out the other end, also near the proximity of a second terminal.

Yet another problem with many existing resistive heating elements is the poor interaction between the heated coils and the flowing air. Resistive heating elements are typically designed such that air flows substantially perpendicular to the rotational axis of the cylinder defined by the coils. Therefore, assuming linear air flow with a flat velocity profile, the air can only contact the coil in two locations on each side of the support. While this model is simplified, the principle clearly indicates that the contact between flowing air and a heated resistive element is minimal. If the air flow is altered to be parallel to the rotational screw axis of the coil the previously stated problem of terminal heating occurs.

One of ordinary skill in the art has therefore been forced to choose between two undesirable choices when employing helical resistive heating elements. One choice leads to terminal heating and high rates of failure. The other choice leads to inefficient heating. Neither of these is acceptable.

One solution to the problems described above is the use of ceramic, honeycomb type, supports with filaments interwoven therein. While this solution mitigates the deficiencies of the elements described in U.S. Pat. No. 5,298,723 other problems occur. Ceramic heaters have the advantage of high efficiency with regards to heat transfer. Honeycomb based ceramic heaters are currently considered in the art to be the heaters of choice due, in part, to the high efficiency. Honeycomb type ceramic cores are expensive to manufacture and the air flow through a honeycomb type ceramic core is, at least partially, blocked thereby requiring higher air pressures at the entrance of the heater to achieve the desired air flow at the exit of the heater. The reliance on higher entrance pressure increases the operating cost of honeycomb based heating elements.

Another widely used solution is the use of an elongated terminal running the length of the support. This solves the problem associated with connection overheating yet other problems occur. The contact between flowing air and the elongated terminal is poor thereby allowing the elongated terminal to become overheated. Any local overheating in a resistive heater represents a potential area of failure. It is one goal of a resistive heating element design to provide consistent temperatures over the entirety of the resistive element to avoid hot spots.

There is not an adequate heating element available in the art capable of solving all of the problems described above.

There has been a long felt need in the art for a resistive heating element which is highly efficient in transferring heat from the resistive element to the flowing fluid but which does not have the deficiency associated with connection overheating. There has also been a long felt desire to accomplish these tasks without the expense, and manufacturing burdens, associated with ceramic, honeycomb type, resistive heating elements.

### SUMMARY

It is an object of the present invention to provide a resistive heating element capable of efficiently transferring heat from a coil to a fluid flowing thereby.

It is another object of the present invention to provide an in line heating element which has improved flow characteristics as determined by the pressure required to achieve a given flow volume.

It is another object of the present invention to provide a resistive heating element which is cost efficient to manufacture and which is less susceptible to failures due to localized hot spots in the resistive heating element.

It is another object of the present invention to provide a heating element, which meets the above described demands, without requiring one, or both, connections to be subjected to heated flowing fluid.

Yet another advantage of the present invention is the improved support of the heating element thereby decreasing the detrimental properties associated with coil instability.

These and other advantages, as will be realized, are provided in an inline heating element for heating a fluid. The heating element comprises an elongated tubular heating chamber comprising an inlet and an outlet opposite to the inlet. A heating element in received in the heating chamber. The heating element comprises an elongated base comprising a first face, a second face parallel to the first face, a first edge and a second edge. A coiled filament circumvents the base wherein the coiled filament comprises a first region wrapped clockwise around the base and a second region wrapped counterclockwise around the base. The first region terminates at a first terminal and the second region terminates at a second terminal. The elongated base is parallel to the elongated tubular heating element; and the fluid flows parallel to the base.

Yet another advantage is provided in an in line heating element for heating a fluid. The element comprises an elongated tubular heating chamber comprising a long tube side and a short tube side, an inlet and an outlet opposite to the inlet. The fluid enters the inlet and traverses parallel to the long tube side and exits the outlet as heated fluid. A heating element is received by the heating chamber. The heating element comprises a rectangular base comprising long base sides and short base sides wherein the long base sides are parallel to the long tube side. A continuous coiled resistive heating element circumventing the base in a double helix wherein the double helix comprises a rotational axis of symmetry and the rotational axis of symmetry is parallel to the long base.

A particular advantage is provided in a heater for heating flowing fluid. The heater comprises a cylindrical heating chamber comprising an inlet at one base and on outlet at a second base. The flowing fluid traverses parallel to the chamber. A resistive heating element is received in the chamber wherein the resistive heating element comprises a rectangular base. The rectangular base comprises a long axis and short axis and the long axis is parallel to the chamber. The base comprises a multiplicity of first slots on one side and a multiplicity of second slots on a second side. A double helix filament is received in the first slots and the second slots.

### BRIEF DESCRIPTION OF DRAWINGS

FIG. 1 is partial cutaway view of an embodiment of the present invention.

FIG. 2 is a top view of the embodiment of FIG. 1 taken along line 2-2 of FIG. 1.

FIG. 3 is a bottom view of the embodiment of FIG. 1 taken along ling 3-3 of FIG. 1.

FIG. 4 is an exploded view of an embodiment of the present invention.

FIG. 5 is a perspective partial cutaway view of a preferred heating element of the present invention.

FIG. 6 is a diagram representing the improved air flow with the inventive heating element.

FIG. 7 is a diagram representing the improved heating efficiency of the inventive heating element.

FIG. 8 illustrates a base with progressive spacing of the slots.

FIG. 9 illustrates a preferred embodiment of the present invention.

FIG. 10 illustrates an exploded view of the base of the embodiment illustrated in FIG. 9.

### DETAILED DESCRIPTION

The present invention relates to a resistive heating element for heating flowing fluid. The invention will be described with reference to the various figures forming a part of this disclosure. The drawings are for the purposes of discussion and are not intended to limit the invention in any way.

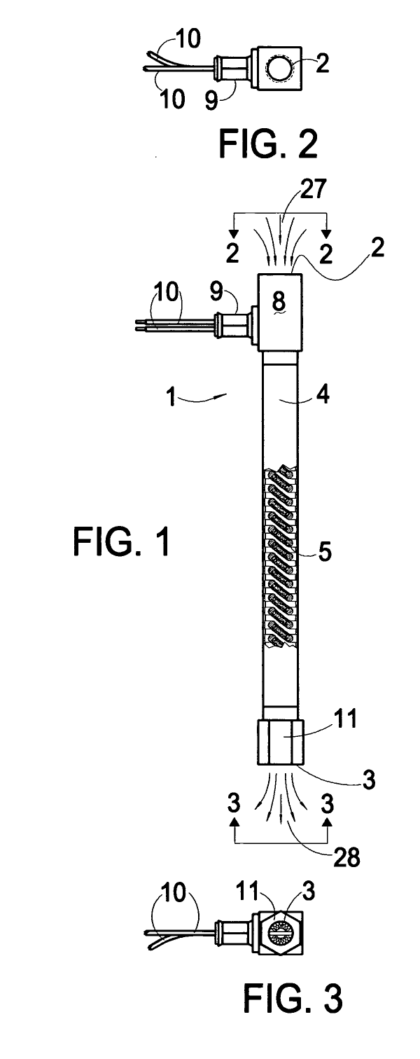

An inline heater, in accordance with the present invention, is illustrated in FIG. 1, and generally indicated at 1. A top view of the inline heating element, taken along line 2-2 of FIG. 1, is provided in FIG. 2. A bottom view of the inline heating element, taken along line 3-3 of FIG. 1, is provided in FIG. 3.

The inline heater, 1, comprises an inlet, 2, and outlet, 3. The inlet, 2, receives the flowing fluid, 27, and preferably represents a fitting which can be coupled to a supply line (not shown) by threads, pressure fittings, adhesives or the like. The manner in which the inlet is coupled to the supply line is not limiting herein. Fluid passes into the heating chamber, 4, and is forced into thermal conductive contact with a heating element, 5. The heating element, 5, will be described with more detail herein. As the fluid transits through the heating chamber, 4, the temperature of the fluid increases based on the temperature of the heating element, 5, the effective contact with the heating element, 5, and the efficiency of heat transfer from the heating element, 5, and the fluid. Heated fluid, 28, exits the outlet, 3. The outlet, 3, may further comprise a nozzle to diffuse or concentrate the heated fluid, or the outlet may be coupled to a secondary supply line wherein heated air is transported to any number of devices such as a work site, assembly or processing equipment, second heater, etc.

Optional baffles in the inlet, 2, and/or outlet, 3, may be provided to diffuse the air thereby mitigating the effect of flow channels which can occur from the configuration of the supply line or to diffuse, or concentrate, the heated fluid as it exits the outlet.

An optional, but preferred, inlet couple, 8, may be attached to the inlet, 2, or heating chamber, 4, by mating threads, welding, adhesive, friction fit, mating voids and protrusions, or the like. The outlet couple may also secure the heating element within the heating chamber and may be an open ring. The inlet couple, 8, may also be integral to the heating chamber, 4, or integral to the supply line. In a preferred embodiment the inlet couple, 8, comprises a terminal couple, 9, through which the electrical terminals, 10, pass for connection to a power source. The terminal couple, 9, allows the electrical terminals, 10, to be encased in a non-conducting conduit, such as flexible or fixed conduit, for protection from thermal or physical stresses if so desired. It is most desired that the terminal couple, 9, be isolated from the fluid flow.

An optional, but preferred, outlet couple, 11, allows the outlet to be connected to a device for directing fluid flow. While not limited thereto, the outlet couple, 11, may comprise, or be attached to, a diffuser or a concentrator. The outlet may also be connected to a conduit for transporting heated fluid to a secondary location; to detectors for monitoring the temperature, volume, velocity or other properties associated with the heated fluid; or to other devices as would be commonly employed in connection with an outlet of a heating element.

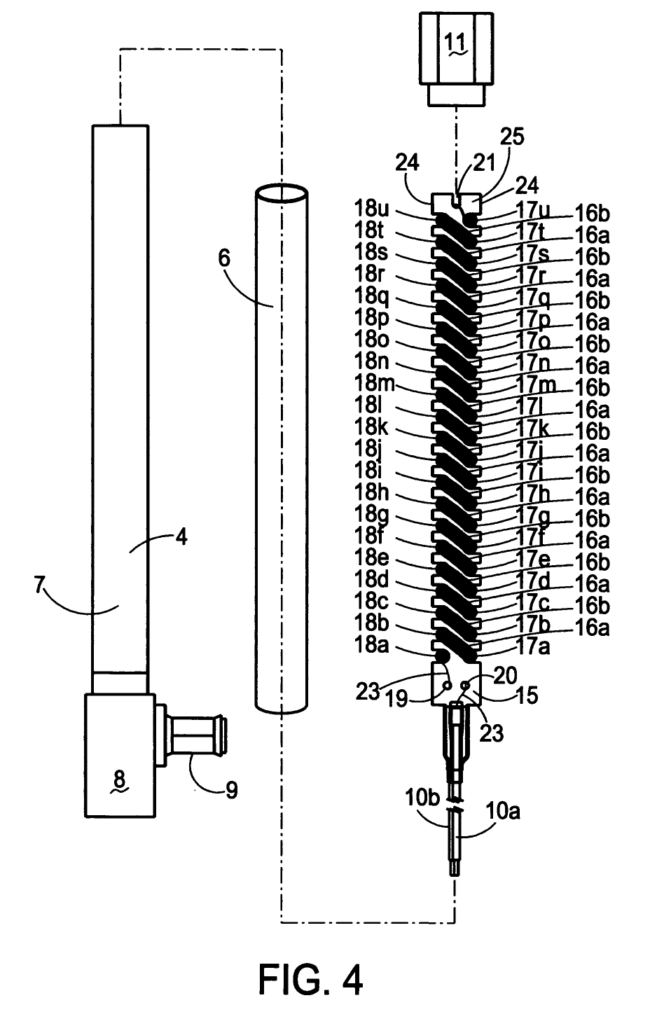

An embodiment of the present invention is illustrated in exploded view in FIG. 4. In FIG. 4, the heating element, 5, comprises a base, 15, with a coiled filament, 16, circumventing the base in a double helical configuration. The base, 15, is preferably an elongated planar element comprising a multiplicity of slots, 17 and 18, along each edge, 24. In a preferred embodiment the slots are, at least partially, aligned. Aligned slots are preferred however with small diameter units offset slots may be preferred due to space limitations.

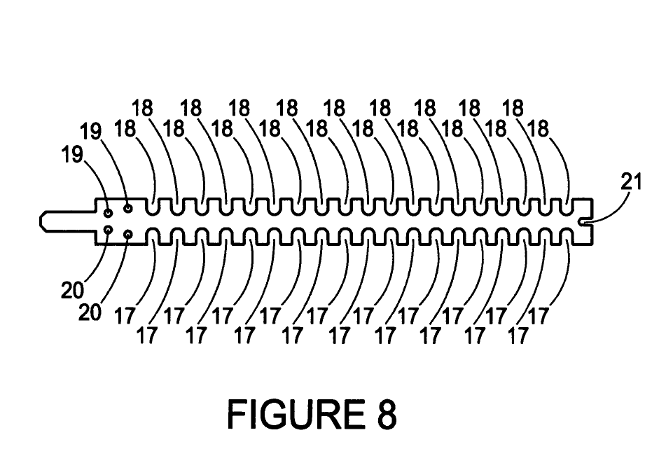

In a particularly preferred embodiment the separation between slots is progressively closer from inlet to outlet. In this embodiment, illustrated in FIG. 8, the helical coils are further apart on the inlet side than on the outlet side. This configuration, progressive slots to achieve better electrical spacing between the adjacent coils with high voltage potential, is preferable for balancing the heat transfer with energy usage.

Referring again to FIG. 4, the slots receive the coiled filament, 16. The coiled filament, 16, is received in offset fashion along the length of the base. By offsetting each wrap one slot the coiled filament, 16, forms a double helix thereby allowing the filament to terminate on the same side of the base, 15. The filaments are preferably electrically connected to electrical terminals, 10. By way of clarification, starting with terminal 10b, filament, 23, passes through passage void, 19, and then, as a coiled filament, is received by slot 18a. The coiled filament is wrapped counterclockwise (as viewed from the terminal end) and received by sequentially offset slots 17b, 18c, 17d, 18e, 17f, 18g, 17h, 18i, 17j, 18k, 17l, 18m, 17n . . . 18u. The coil is received by terminal slot, 21. After being received by optional terminal slot, 21, the rotation of the wrap is clockwise (as viewed from the terminal end) and the coil is received by sequentially offset slots 17u, 18t, 17s, 18r, 17q, 18p, 17o, 18n, 17m . . . 17a. Filament, 23, then passes through passage void, 20, and is in electrical connection with electrical terminal 10a. Two passage voids, as illustrated in FIG. 8, may be employed to further secure the coil. The use of sequentially offset slots insures that each subsequent coil visible on a planar surface of the base is separated, relative to the length of the continuous resistive element. For example, each coil segment, 16a, from the clockwise wrap is separated from each adjacent coil segment, 16b, from the counterclockwise wrap. This double helix configuration greatly increases the efficiency of the heating element which is unexpected in the art.

The passage voids, and terminal voids are optional, but preferred. The passage voids allow the initial position of the filament to be fixed prior to initiation of the wrapping procedure. The terminal void, likewise, insures that the wrap is secured prior to the return wrap initiation.

Heating element, 5, is received by an optional, but preferred, liner, 6, which is in-turn, received in the heating chamber, 4. The electrical terminals, 10, preferably protruding through the optional terminal couple, 9. Optional outlet couple, 11, and optional inlet couple, 8, secure the heating element into a fixed position within the heating chamber in an orientation which avoids coils contacting the interior surface of the heating chamber. It is most preferred that the heating chamber comprise an interior liner, 6, which is both thermally and electrically insulating. Preferably liners include flexible mica, thin mica sheets, quartz or ceramic. Flexible mica and thin mica sheets are preferred due, in part, to the cost advantages versus quartz and ceramic. Quartz and ceramic are excellent insulators and provide less degradation but the cost is prohibitive relative to mica for most applications. In one embodiment a ground wire, 7, is attached to the heating chamber as a safety feature.

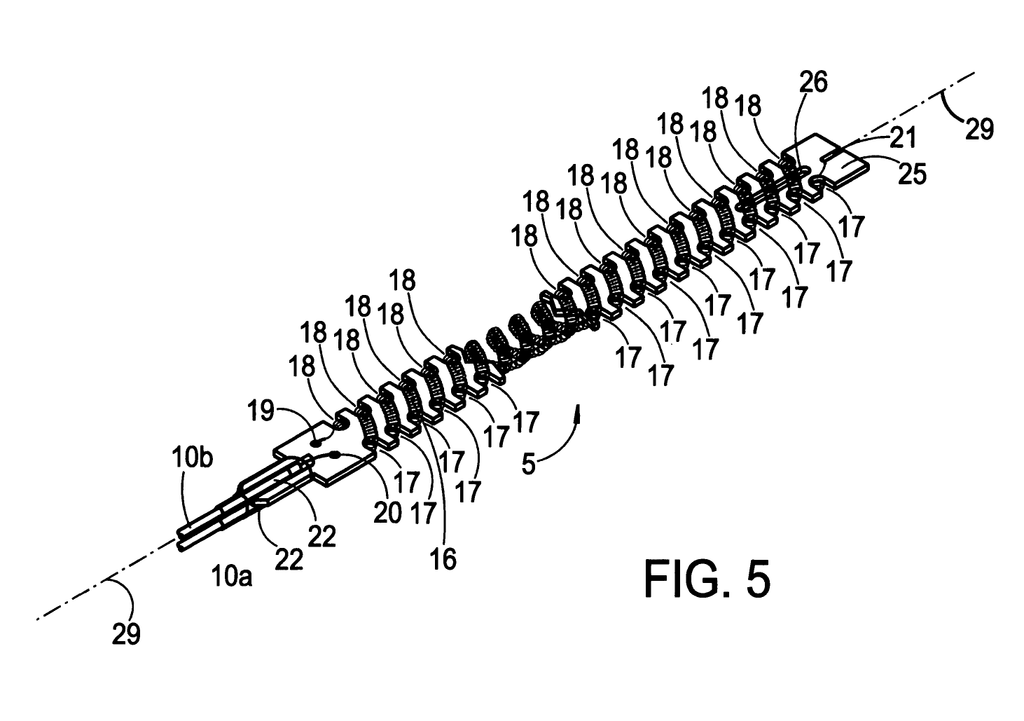

A partial cut-away view of a preferred heating element, 5, is provided in FIG. 5. In FIG. 5 a portion of the base is cut-away to allow a portion of the double helix coiled filament, 16, to be visualized. The double helix comprises two parallel matching wraps with a common axis of rotation and radius with each wrap offset such that they do not come into contact with each other. The face, 25, may comprise interior slots, 26, to increase air flow channels if so desired or for slidably engaging multiple base elements. The rotational axis, 29, is defined as the axis of rotation of the cylinder formed by the exterior of the double helix. The rotational axis is parallel to the long axis of the rectangular base.

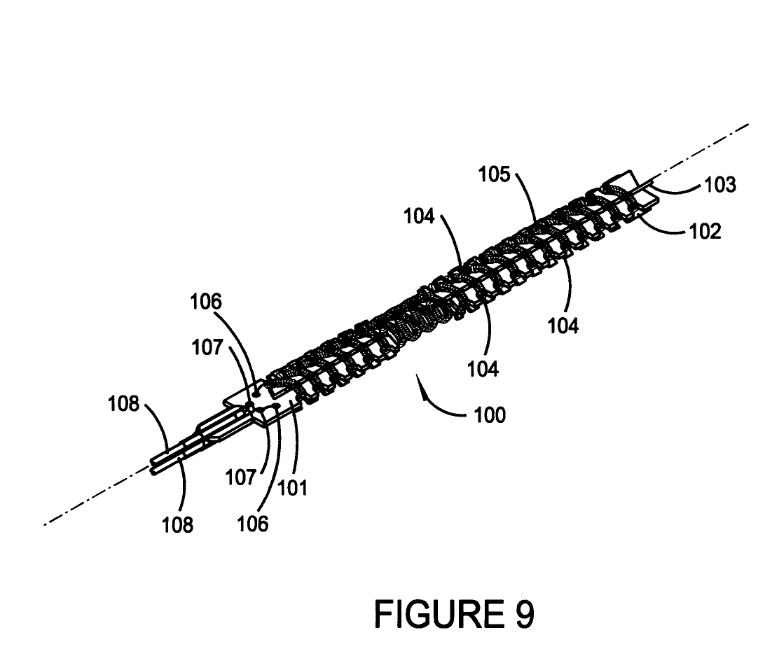

A preferred heating element is illustrated in FIG. 9. In FIG. 9, the heating element, 100, comprises a base. The base comprises at least two, and preferably three based elements indicated as a first base element, 101, a second base element, 102, and a third base element, 103, The three base elements are slidably engaged, as will be described further, to form a core around which the filament, 105, is wrapped in a double helix fashion as described herein. The multiple base elements provide support for the filament without detrimental impact on the performance of the heater. Each base element comprises slots, 104, which are aligned in a helical fashion as would be realized from the description herein. The first base element, 102, preferably comprises first passage voids, 106, and second passage voids, 107, through which the filament is passed as described herein. The filament terminates at terminals, 108, as would be understood from the present description.

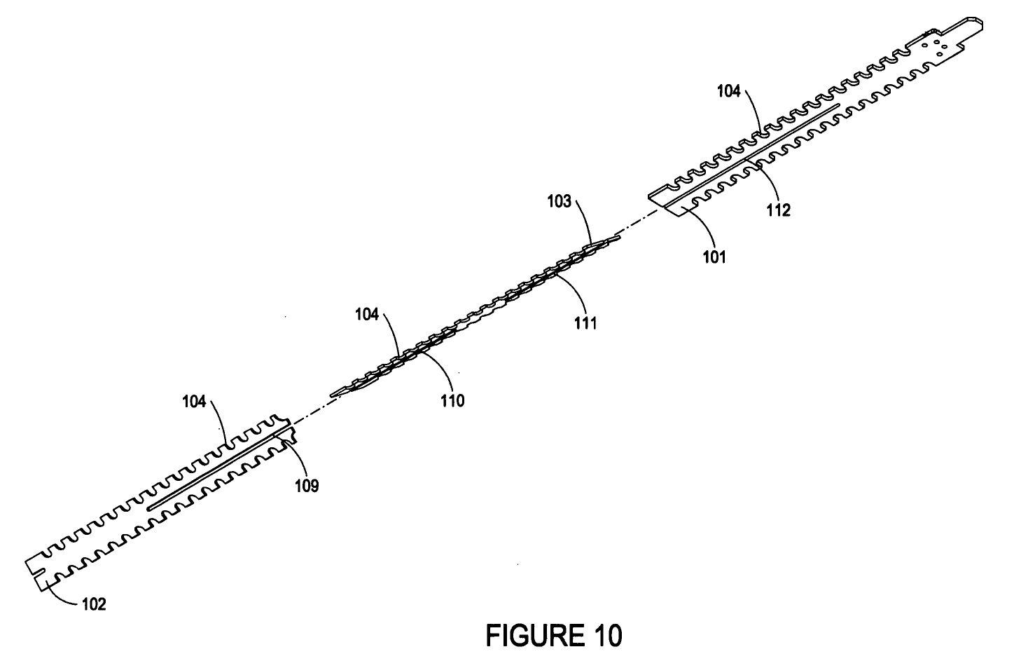

An exploded view 6f the base elements is provided in FIG. 10. In FIG. 10, the first base element, 101, comprises an elongated slot, 112. The second terminal element, 102, comprises an elongated slot, 109, and the third base element comprises a first slot, 110, and a second slot, 111. The first and third base elements are slidably engaged to form a base in the cross-sectional shape of an “X”. The second base element is then slidably engaged with the first and third base elements to form an approximately rotationally symmetric element.

For the purposes of the present invention, an in line heater comprises an elongated enclosed heating element wherein the length through the heating chamber is longer than the cross-sectional diameter of the heating chamber.

It would be understood that the heating chamber is preferably configured to insure that heating coils cannot easily come into contact with the interior surface of the heating chamber. This may be accomplished in several ways. In a preferred embodiment the heating chamber has an insulating liner. In one embodiment, the depth of the slots is larger than the exterior diameter of the cylinder defined by the coils. This insures that the base will contact the interior surface of the heating chamber prior to the coils coming into contact with the interior surface of the heating chamber. The width of the base is preferably wider than the outer diameter of the cylinder defined by the double helix. The width of the base is preferably chosen to be small enough to be easily received by the heating chamber with minimal lateral movement therein. A clearance of approximately 0.010″ to approximately 0.015″ is most preferred.

The heating chamber is preferably cylindrical, more preferably a right cylinder with a preferably round base. Other shapes such as trigonal, square, pentagonal, hexagon or polygonal, are suitable for demonstration of the teachings herein as are oblong configurations such as elliptical. It is most preferred that the interior shape, and dimensions, be chosen in tandem with the size of the base to prohibit the coils from contacting the interior of the heating chamber.

The resistance wire is chosen to maximize heat transfer. The greatest efficiency will be achieved when the primary mode of heat transfer is convection versus radiation. This implies that surface temperature must be kept relatively cool. It has been found that for most applications the heat flux (also referred to as watt density which is watts per surface area of wires) should be kept under 100 W/m². If the pitch of the coil is to small, convection is inhibited from the inability of the air to flow between adjacent turns. In addition, when the adjacent coil turns are in close proximity the wire surface temperature is maintained at a higher temperature from the radiation exchange between adjacent turns. Both scenarios result in lower heat transfer efficiency. Best results have been achieved when the coil helix pitch is in the range of 2.5 times wire diameter to 4 times wire diameter. The wire gauge can be selected for a desired watt density, and the inside diameter (arbor diameter) can be varied to achieve the desired coil helix pitch. In addition, to insure the coil does not sag or creep at high temperatures a coil of adequate stiffness can be achieved if the ratio of arbor diameter to wire diameter is less than 10.

The base is any support material typically employed in electrical resistance heaters. Particularly preferred materials include mica, steatite, cordierite, quartz and ceramic with mica being most preferred. Mica is preferred due, in part, to the cost and ease of fabrication. For higher temperature, and higher strength applications ceramic is preferable but the tooling required to form ceramic parts typically limits the desire to utilize ceramic.

The coiled filament is any material typically employed in the manufacture of resistant heaters. Resistive alloys are preferred. Particularly preferred resistive alloys include nickel chrome alloy and iron chrome aluminum alloys. Nickel chrome alloys are available commercially comprising approximately 12-25%, by weight, chromium; approximately 2.756%, by weight, aluminum and the balance iron. A preferred example is Kanthal AF. Nickel chromium alloys are available commercially comprising from approximately 35-80%, by weight, nickel; approximately 16-20%, by weight, chromium and minor portions of such materials as silicon, manganese, carbon, iron and sulfur. A particularly preferred nickel chromium alloy comprises approximately 80%, by weight, nickel and approximately 20%,by weight chromium.

The in line heater of the present invention is particularly suitable for heating air but other fluids can be heated utilizing the inventive heater without departing from the scope of the present invention. Gaseous fluids are more preferable than liquid fluids with air being the most preferred.

### Experimental

### EXAMPLE 1

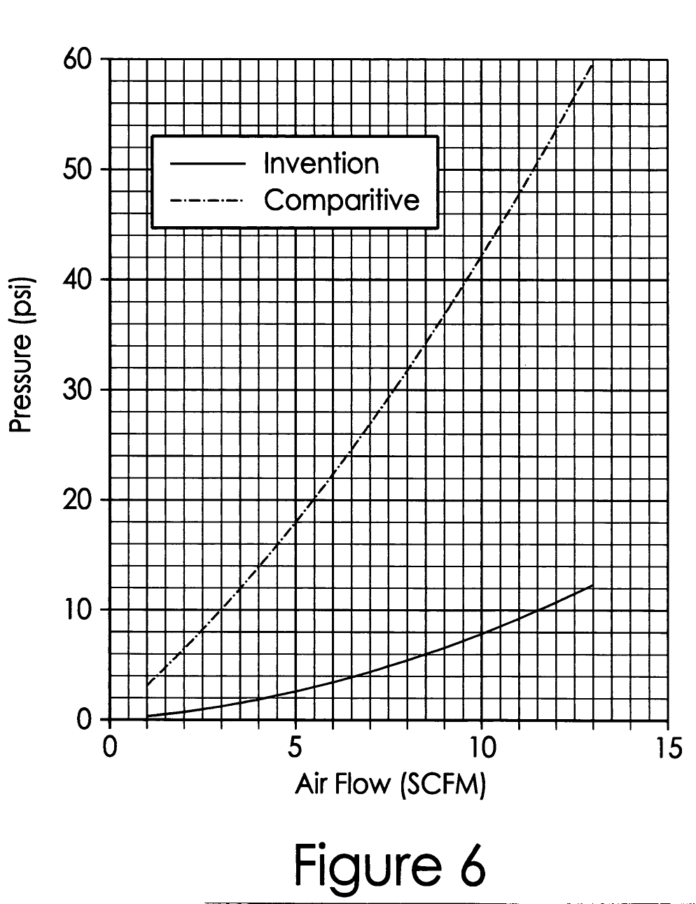

A heating element was prepared in accordance with the present invention. The heating element comprised an approximately 4.7 inch by approximately 0.4 inch base with 21 slots cut along each side. A 27.9 Ohm, 25 gauge (0.179″ diameter) Kanthal AF coil was wrapped in a double helix with an outside diameter (OD) of approximately 0.115″ and an arbor of approximately 0.075″. As a control a conventional ceramic heater comprising a 27.9 Ohm, 25 gauge (0.179″ diameter) Kanthal AF wire was wound in serpentine fashion through six holes of a ceramic core assembly. The core assembly was approximately 4.315″ long comprising six approximately 0.110″ diameter holes on an approximately 0.285″ diameter bolt circle with an outer diameter of approximately 0.435″. Each heating element was subjected to an air flow analysis. The results are provided in FIG. 6. The results provided in FIG. 6 indicate that the pressure required to achieve a given air flow is much less for the inventive heating element than for the ceramic heating element. For example, to achieve an air flow of 6 SCFM the comparative example requires a pressure of approximately 22 pounds per square inch (psi) versus approximately 3.5 psi for the inventive embodiment.

### EXAMPLE 2

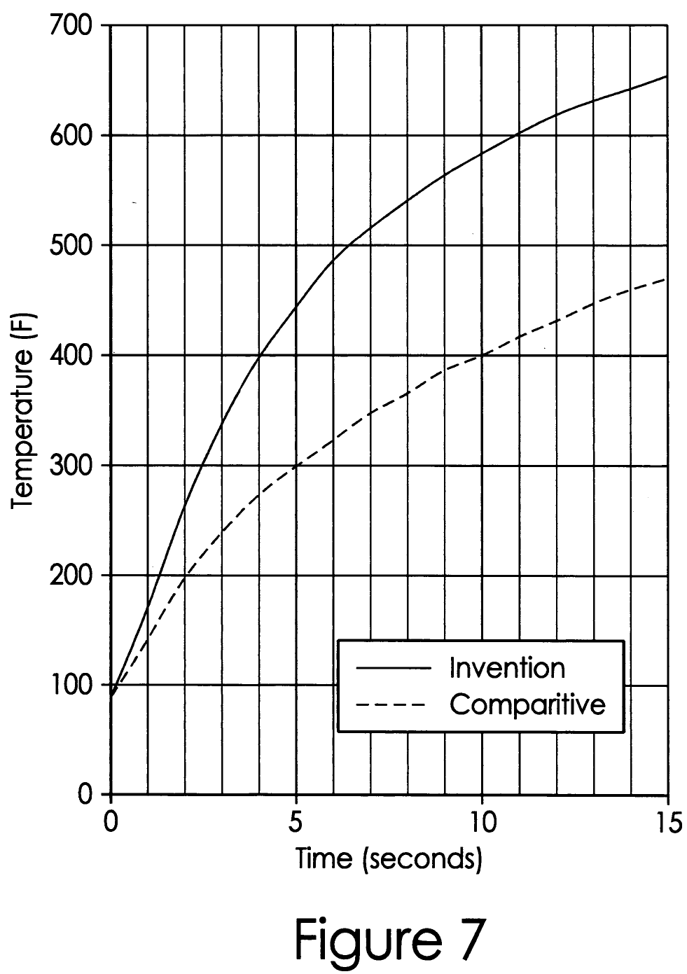

The heating elements of Example 1 were heated at 500 watts at an air flow rate of 100 SCFH. The temperature of air exiting each heater was monitored as a function of time using a type K thermocouple positioned centrally in the heater exhaust and approximately 0.80″ from the end of the mica support or ceramic core. The thermocouple output was captured with a Hewlett Packard 34970A data acquisition unit linked to a computer. The results are provided in graphical form in FIG. 7. The efficiency of heating for the inventive heater was demonstrated to be greatly superior to that of the ceramic heater. For example, after approximately 5 minutes the air exiting the inventive heater was approximately 450° F. while the air exiting the comparative heater was only approximately 300° F. This increase of approximately 50%, coupled with the lower required air pressure to achieve an equivalent air flow demonstrates a performance which greatly exceeds that considered in the art to be achievable with a base supported coil in an in line heater.

Claimed is:

1. An inline heating element for heating a fluid comprising:
an elongated tubular heating chamber comprising an inlet and an outlet opposite to said inlet;
a heating element in said heating chamber wherein said heating element comprises;
an elongated base comprising at least two slidably engaged base elements;
a coiled filament circumventing said base wherein said coiled filament comprises a first region wrapped clockwise around said base and a second region wrapped counterclockwise around said base and wherein said first region terminates at a first terminal and said second region terminates at a second terminal;
wherein said elongated base is parallel to said elongated tubular heating element; and
said fluid flows parallel to said base.

2. The inline heating element of claim 1 wherein at least one of said at least two base elements comprises at least one element selected from the group consisting of mica, steatite, cordierite, quartz and ceramic.

3. The inline heating element of claim 1 comprising three slidably engaged base elements.

4. The inline heating element of claim 1 further comprising a liner between said base and said coiled filament.

5. The inline heating element of claim 4 wherein said liner is flexible mica, mica sheet, quartz or ceramic.

6. The inline heating element of claim 1 wherein said filament is a resistive alloy.

7. The inline heating element of claim 1 wherein said filament comprises a nickel chrome alloy.

8. The inline heating element of claim 1 wherein each base element of said at least two base elements further comprises slots for receiving said coiled filament.

9. An in line heating element for heating a fluid comprising:
an elongated tubular heating chamber comprising a long tube side and a short tube side, an inlet and an outlet opposite to said inlet wherein said fluid enters said inlet and traverses parallel to said long tube side and exits said outlet as heated fluid;
a heating element received by said heating chamber wherein said heating element comprises:
a rectangular base comprising at least two slidably engaged base elements and said base comprises long base sides and short base sides wherein said long base sides are parallel to said long tube side; and
a continuous coiled resistive heating element circumventing said base in a double helix wherein said double helix comprises a rotational axis of symmetry and said rotational axis of symmetry is parallel to said long base.

10. The in line heating element of claim 9 wherein said base further comprises slots for receiving said continuous coiled resistive heating element.

11. The in line heating element of claim 9 wherein said slots are aligned.

12. The in line heating element of claim 10 wherein a separation between slots increases with distance along said base.

13. A heater for heating flowing fluid comprising:
a cylindrical heating chamber comprising an inlet at one base and on outlet at a second base and wherein said flowing fluid traverses parallel to said chamber;
a resistive heating element received in said chamber wherein said resistive heating element comprises:
at least two slidably engaged base elements forming a rectangular base wherein each said base element comprises a long axis and short axis and said long axis is parallel to said chamber and each said base element comprises a multiplicity of first slots on one side and a multiplicity of second slots on a second side; and
a double helix filament received in said first slots and said second slots.

14. The heater of claim 13 wherein said first slots and said second slots are aligned.

15. The heater of claim 13 wherein a separation between said first slots increases with distance along said base.

16. The heater of claim 13 wherein said filament is a resistive alloy.
